(19) United States
(12) Patent Application Publication
(10) Pub. No.: US 2025/0196944 A1
(43) Pub. Date: Jun. 19, 2025

(54) SLEEPER CAB FOR ELECTRIC VEHICLE

(71) Applicants: Chad BURCHETT, Browns Summit, NC (US); VOLVO TRUCK CORPORATION, Göteborg (SE)

(72) Inventor: Chad BURCHETT, Browns Summit, NC (US)

(73) Assignee: VOLVO TRUCK CORPORATION, Göteborg (SE)

(21) Appl. No.: 18/849,202

(22) PCT Filed: Mar. 25, 2022
(86) PCT No.: PCT/US2022/021907

§ 371 Date: Sep. 20, 2024

(51) Int. Cl. B62D 33/06

(52) U.S. Cl. CPC B62D 33/0612; B60Y 2200/148; B60Y 2200/90; B60Y 2400/10; B60Y 2400/112

(57) ABSTRACT

A sleeper cab for an electric vehicle. The sleeper compartment is provided with side walls, a floor, and a bunk space. The bunk space is provided with an energy storage system receptacle box. The energy storage system receptacle box is provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment from at least one of the side walls or the floor and that is isolated from the sleeper compartment by the receptacle box wall. At least a portion of an energy storage system is inserted into the cavity so that at least a portion of the energy storage system is located above the floor.

### TECHNICAL FIELD

Embodiments of the present disclosure relate generally to a sleeper cab for an electric vehicle, and more specifically, to a sleeper cab having a sleeper compartment capable of housing an energy storage system of an electric vehicle.

### BACKGROUND

With the development of battery technologies, electric vehicles became more and more popular. All such electric vehicles, including battery electric vehicles, hybrid electric vehicles and fuel cell electric vehicles, need to be equipped with a vehicle battery. The more robust onboard battery system, the more power the vehicle may have and the longer driving range it may offer. It's quite common that many drivers of electric vehicles suffer from range anxiety, i.e., an anxiety over running out of electricity before the vehicle reaches its destination. This anxiety exists because unlike a traditional vehicle which can be refilled with fuel quickly, an electric vehicle may have to be towed when its battery runs out of charge and recharging is unavailable. Therefore, a longer driving range means a more comfortable and possibly a longer trip for drivers. This is more important for heavy trucks which are used for transporting cargo.

However, because of limited space of vehicles, providing sufficient space for the onboard batteries is a concern. There may be restricted space on a chassis of a vehicle which may be used for mounting batteries. Some trucks, particularly over-the-road or long haul tractor-trailer trucks, are equipped with extended cabs to accommodate a sleeper compartment which may provide a living space for the driver to sleep and rest. This kind of cab may also be referred to as a sleeper cab. For a truck having a sleeper cab, batteries may be mounted on a gantry behind the sleeper cab. The problem is, stacking a battery on the gantry creates a gap between the sleeper cab and a trailer. The gap may degrade the aerodynamic performance due to an airflow through the gap. There may be also a safety concern that an occupant within the sleeper compartment may be injured because the gantry may swing into the back of the cab during a crash. Therefore, a better utilization of the space on an electric vehicle to maximize the available space for a battery is desired.

### BRIEF SUMMARY

According to an embodiment, a sleeper cab for a heavy truck may comprise a sleeper compartment with side walls, a floor, and a bunk space configured to provide a sleeping space for a driver, the bunk space provided with an energy storage system receptacle box provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment from at least one of the side walls or the floor and that is isolated from the sleeper compartment by the receptacle box wall; wherein, at least a portion of an energy storage system is inserted into the cavity so that at least a portion of the energy storage system is located above the floor.

According to an embodiment, a sleeper cab for a heavy truck may comprise a sleeper compartment with side walls, a floor, and a bunk space configured to provide a sleeping space for a driver, the bunk space provided with an energy storage system receptacle box provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment space from at least one of the side walls or the floor and that is isolated from the sleeper compartment by the receptacle box wall; a driving space configured to provide space for the driver to operate the heavy truck, the driving space having a floor, and a separation wall forming a border with the sleeper compartment; and an energy storage system, wherein at least a portion of the energy storage system is inserted into the cavity so that at least a portion of the energy storage system is located above the floor of the sleeper compartment.

### ASPECTS OF THE INVENTION

According to an embodiment, a sleeper cab for a heavy truck may comprise a bunk space configured to provide a sleeping space for a driver, the bunk space provided with a bunk floor and bunk side wall that define the bunk space; and an energy storage system receptacle box provided with a receptacle box wall that extends inward into the bunk space from at least one of the bunk side wall or the bunk floor and that includes a bunk facing side and cavity defining side opposite the bunk facing side, the cavity defining side defining a cavity that extends into the bunk space from at least one of the bunk side wall or the bunk floor and that is isolated from the bunk space by the receptacle box wall; wherein, at least a portion of an energy storage system is inserted into the cavity so that at least a portion of the energy storage system is located above the bunk floor.

According to an embodiment, wherein the cavity is accessible from an exterior of the heavy truck.

According to an embodiment, wherein a vehicle body floor of the sleeper cab includes the floor of the sleeper compartment.

According to an embodiment, wherein the energy storage system is located within the receptacle box and supported by the floor.

According to an embodiment, wherein the floor within the cavity is at least partially cut out and the energy storage system is located on an energy storage system support that is inserted into the cavity.

According to an embodiment, wherein the energy storage system is releasably inserted into the cavity so that the energy storage system automatically separates from the heavy truck in an emergency event.

According to an embodiment, wherein a vent is provided that is selectively opened to release gasses generated by the energy storage system from the cavity.

According to an embodiment, wherein the energy storage system receptacle box is a firewall between the cavity and the sleeper cab.

According to an embodiment, wherein the energy storage system is an electric battery system.

According to an embodiment, wherein the energy storage system is a fuel storage system.

According to an embodiment, wherein the cavity is at least partially located underneath a mattress located in the bunk space.

According to an embodiment, further comprising a temperature regulation system that regulates a temperature of at least one of the cavity and the energy storage system.

According to an embodiment, wherein the temperature regulation system of the energy storage system is thermally connected to a temperature regulation system of the sleeper cab.

According to an embodiment, wherein the energy storage system is removable from a chassis of the heavy truck without removing the sleeper cab from the chassis of the heavy truck.

According to an embodiment, wherein the energy storage system comprises a support structure that is configured to receive forks of a forklift to remove the energy storage system from a chassis.

According to an embodiment, a sleeper cab for a heavy truck may comprise a sleeper compartment with side walls, a floor, and a bunk space configured to provide a sleeping space for a driver, the bunk space provided with an energy storage system receptacle box provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment space from at least one of the side walls or the floor and that is isolated from the sleeper compartment by the receptacle box wall; a driving space configured to provide space for the driver to operate the heavy truck, the driving space having a floor, and a separation wall forming a border with the sleeper compartment; and an energy storage system, wherein at least a portion of the energy storage system is inserted into the cavity so that at least a portion of the energy storage system is located above the floor of the sleeper compartment.

According to an embodiment, wherein the energy storage system is releasably inserted into the cavity that the energy storage system automatically separates from the heavy truck in an emergency event.

According to an embodiment, wherein a vent is provided that is selectively opened to release gasses generated by the energy storage system from the cavity.

According to an embodiment, energy storage system receptacle box is a firewall between the cavity and the sleeper cab.

According to an embodiment, wherein the separation wall defines an exterior surface of the sleeper cab, wherein the exterior surface is a firewall between the cavity and the sleeper cab.

According to an embodiment, wherein the energy storage system is an electric battery system.

According to an embodiment, wherein the energy storage system is a fuel storage system.

According to an embodiment, comprising a temperature regulation system that regulates a temperature of at least one of the cavity and the energy storage system.

According to an embodiment, wherein the energy storage system is removable from a chassis of the heavy truck without removing the sleeper cab.

According to an embodiment, wherein the temperature regulation system of the energy storage system is thermally connected to a temperature regulation system of the sleeper cab.

According to an embodiment, wherein the energy storage system comprises a support structure that is configured to receive forks of a forklift to remove the energy storage system from a chassis.

### BRIEF DESCRIPTION OF DRAWINGS

The description below refers to the following drawings of which:

FIG. 1 shows an exterior view of a sleeper cab of a truck, according to an embodiment of the disclosure;

FIG. 2A shows an interior view of the sleeper cab shown in FIG. 1, according to an embodiment of the disclosure;

FIG. 2B shows another interior view of another sleeper cab, according to an embodiment of the disclosure;

FIG. 2C shows another interior view of another sleeper cab, according to an embodiment of the disclosure;

FIG. 3 shows an ESS receptacle box of the sleeper cab shown in FIG. 1, according to an embodiment of the disclosure;

FIG. 4 shows a perspective view of the sleeper cab shown in FIG. 1, which houses an ESS, according to an embodiment of the disclosure; and

FIG. 5 shows another perspective view of the sleeper cab shown in FIG. 1, which houses an ESS, according to another embodiment of the disclosure.

### DETAILED DESCRIPTION

The present disclosure relates to an electric vehicle that may include an energy storage system. The electric vehicle may be a battery electric vehicle, a hybrid electric vehicle, or a fuel cell electric vehicle. The electric vehicle may be a heavy truck including a tractor and a trailer. The tractor portion may have an extended cab which includes a sleeper compartment.

The sleeper compartment may comprise side walls, a floor, and a bunk space configured to provide a sleeping space for a driver. The bunk space may be provided with an energy storage system receptacle box. The energy storage system receptacle box may be provided with a receptacle box wall that extends inward into the sleeper compartment from at least one of the side walls or the floor. The receptable box wall includes a sleeper compartment facing side and a cavity defining side opposite the sleeper compartment facing side. The cavity defining side may define a cavity. The cavity may extend into the sleeper compartment from at least one of the side walls or the floor, and may be isolated from the sleeper compartment by the receptacle box wall. At least a portion of an energy storage system (ESS) is inserted into the cavity so that at least a portion of the energy storage system is located above the floor.

A sleeper cab may comprise the sleeper compartment and a driving space. The driving space may be configured to provide space for the driver to operate the heavy truck. The driving space may have a floor and a separation wall forming a border with the sleeper compartment. The ESS may be an electric battery system or a fuel storage system.

Configuring the structure in this manner allows the bunk space of the sleeper compartment and the sleeper cab to be utilized in a more efficient way, thereby additional space may be available for the ESS. The additional space may be used for housing existing or additional batteries of an electric vehicle. In the latter case, additional power may be supplied for a vehicle (e.g., for a traction voltage system of the vehicle). This may be more advantageous for fuel cell electric vehicles because such vehicles may have to carry a battery to store the electric energy created by the fuel cell.

The phrase “sleeper cab” may be used to refer to an actual sleeper compartment of a truck, a driver compartment which is extended to have a sleeper compartment, a driver compartment and a sleeper compartment to which it is connected to, as well as a tractor portion having a sleeper compartment thereof. In some embodiments, the terms tractor, heavy truck and the like are intended to refer to the tractor portion of a tractor-trailer type electric vehicle.

Details of exemplary sleeper compartments and sleeper cabs to achieve the aforementioned advantages and benefits are described herein. However, alternatives to the structure, layout, size, arrangement, etc., are contemplated without departing from the goals and scopes of an improved sleeper compartment and sleeper cab according to embodiments of the present disclosure.

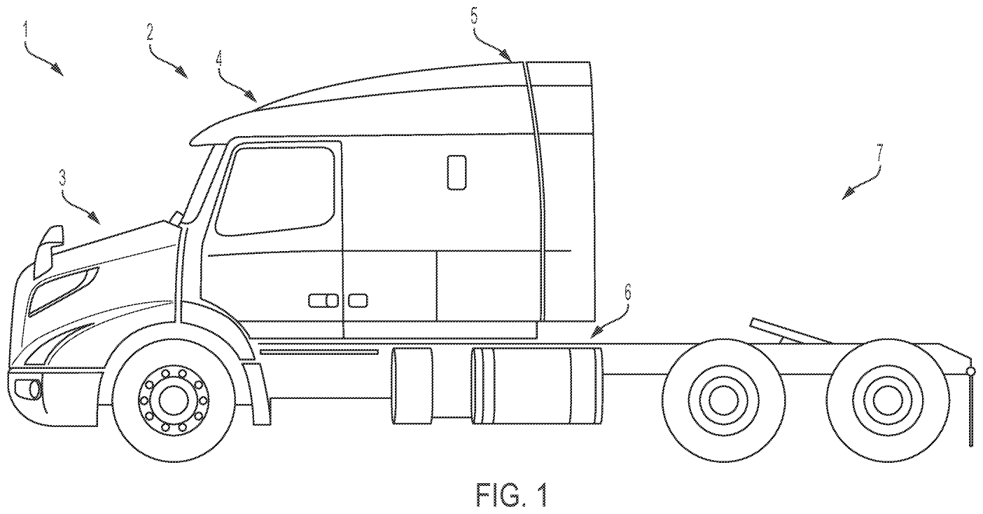

Referring to FIG. 1, a vehicle 1 is shown. The vehicle 1 may be an electric vehicle. The vehicle 1 may be a heavy truck having a tractor 2. The tractor 2 may include a hood 3, a driver compartment 4, a sleeper compartment 5, a chassis 6 and a trailer receiving area 7. The sleeper compartment 5 may be originally constructed to be integral with the driver compartment 4. The drive compartment 4 and the sleeper compartment 5 together may be referred to as a sleeper cab. In another embodiment, a sleeper compartment may be designed and manufactured separately and mated with a driver compartment during a subsequent assembly. In this case, such prefabricated sleeper compartment itself may be referred to as a sleeper cab as well. FIG. 1 illustrates an exterior view of the sleeper cab from the driver side. It may be understood that the sleeper cab may have a symmetrical exterior view at the passenger side.

With continued reference to FIG. 1, the driver compartment 4 may be in the front of the sleeper cab, and the sleeper compartment 5 may be in the rear. The driver compartment 4 may provide with a driving space for the driver to operate the heavy truck. Specifically, the driver compartment 4 normally may have two seats, a driver seat and a passenger seat, which are spaced apart in the front. In another embodiment, the driving space may have a driving floor and a separation wall. The separation wall may separate the driver compartment 4 from the sleeper compartment 5 and forms a border with the sleeper compartment 5. In yet a further embodiment, the separation wall may further form an exterior surface of the sleeper cab.

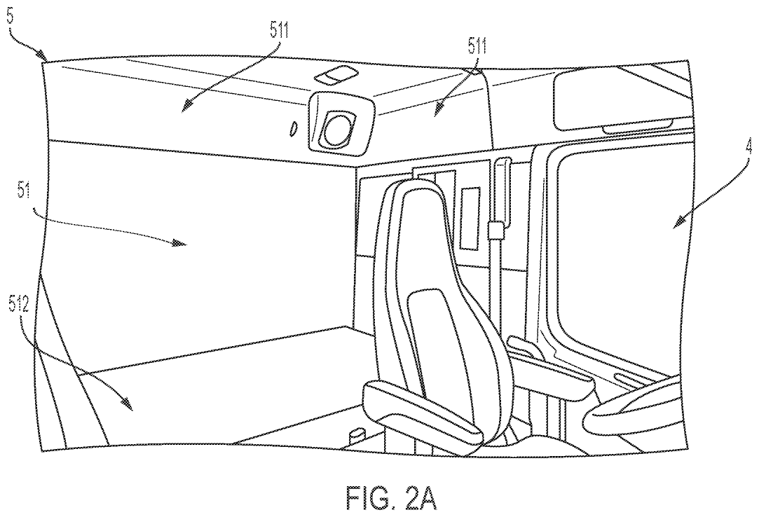

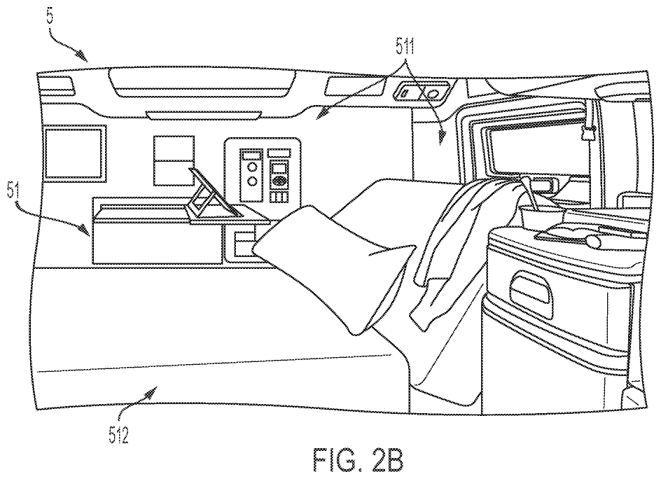

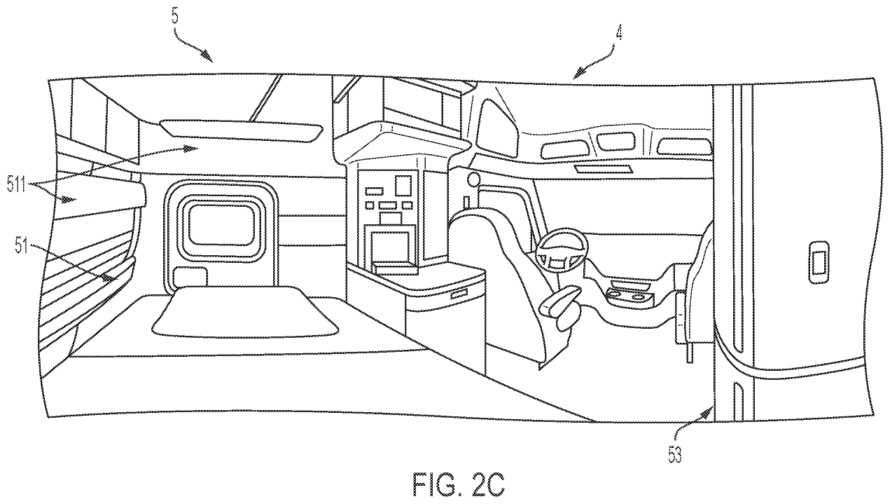

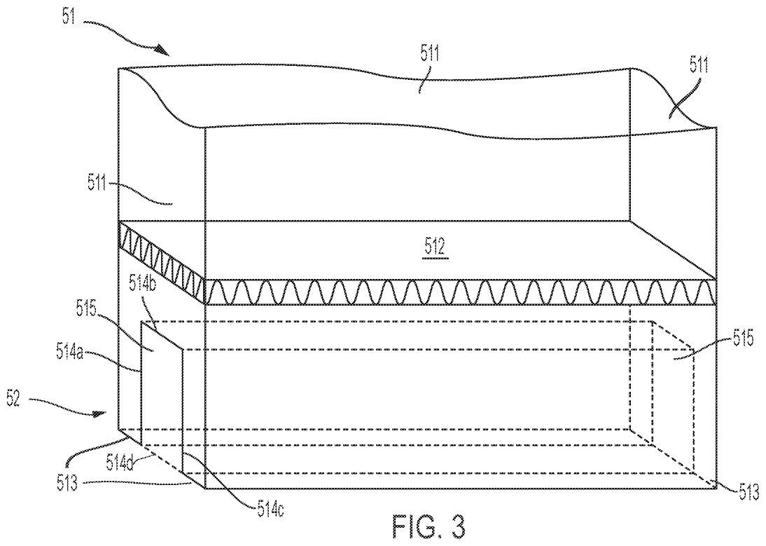

The sleeper compartment 5 may have various designs with various size to meet different needs. FIGS. 2A-2C show an exemplary interior view of a sleeper cab respectively. FIG. 2A shows an interior view of the sleeper cab shown in FIG. 1. The sleeper compartment 5 may be a compact one which is right behind the driver compartment 4. The sleeper compartment 5 may comprise a bunk space 51, side walls 511, a mattress 512, and a floor (not visible in FIG. 2A, shown in FIG. 3 as 513). The floor of the sleeper compartment 5 may be separate from the driving floor of the driver compartment 4. Alternatively, there may be an integral floor which may also be a vehicle body floor. As shown in FIG. 2A, the bunk space 51 may located by side wall 511 on the driver side and at the back of the sleeper cab (which may also be an exterior surface of the sleeper cab) respectively. There may be another side wall 511 on the passenger side, which is not shown in the figure. Within the scope of the present embodiment, the bunk space 51 may also be located elsewhere in the sleeper compartment 5.

FIG. 2B shows another interior view of a sleeper cab. The sleeper compartment 5 may have a larger size and thereby provide more resting space. Accordingly, the bunk space 51 is larger. More appliances are provided within the sleeper compartment 5 as well (e.g., a mini fridge on the floor besides the mattress, a flatscreen TV hanging on the side wall 511, a foldable side table which may flip up and out over the mattress 512). A luxury interior view of a sleeper cab is shown in FIG. 2C. There is more space for both the driver compartment 4 and sleeper compartment 5. Therefore, a mini fridge with a microwave up above, may be provided between the bunk space 51 and a driver seat. A cabinet or closet 53 may be provided behind the passenger seat and in front of the bunk space 51. In another embodiment, a sleeper cab may be provided with a dual-bunk set-up in the bunk space (not shown in FIG. 2C). In another embodiment, a sleeper cab may be provided a shower area (not shown in FIG. 2C). Therefore, it may be understood that the place of a bunk space within a sleeper cab may be different (e.g., located at a corner of a sleeper cab instead of transversely across the whole back area), depending on a design and specific size of the cab.

Referring to FIG. 3, and with continued reference to FIG. 2, one example of ESS receptacle box 52 of the sleeper cab within the scope of the present embodiment which is illustrated in FIG. 1 is shown. The ESS receptacle box 52 may form part of the mattress support underneath the mattress 512 in the bunk space 51 or may occupy the space underneath a separate mattress support, thereby the space underneath the mattress 512 may be used for housing an ESS system.

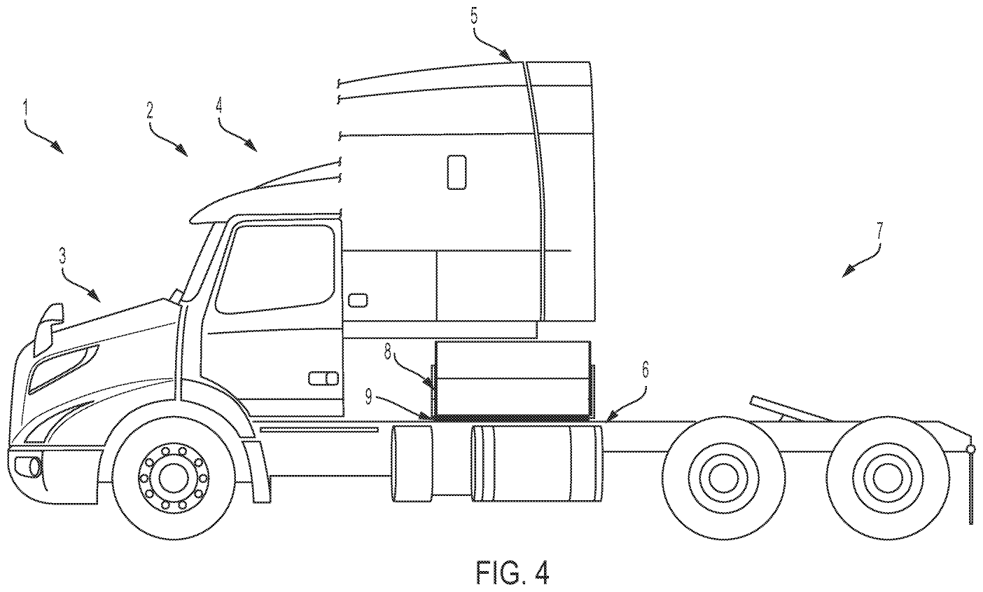

As shown in FIG. 3, a bunk space 51 includes a mattress 512 and an ESS receptacle box 52. The ESS receptacle box 52 may have a receptable box wall 514. The receptable box wall 514 may be located forward of the rear side wall 511. The receptable box wall 514 may extend between the side walls 511 at the driver side and passenger side, into the sleeper compartment 5 from the floor 513 and the side walls 511 respectively. Accordingly, the receptable box wall 514 forms three sides 514a, 514b, and 514c, leaving an opening side 514d indicated in dotted lines in FIG. 3. The side 514b and side 514d may face opposite to each other. The side 514b may face the bunk mattress 512 thus be referred to as a sleeper compartment facing side 514b. The side 514d is an opening side, which may help defining a cavity 515 thus be referred to as a cavity defining side 514d. As shown in FIG. 3, the cavity 515 may extend into the sleeper compartment 5 from the side walls 511 and the floor 513 (e.g., 3 feet long and 2 feet high). The cavity 515 may be used to house or receive the ESS 8, which is shown in FIG. 4.

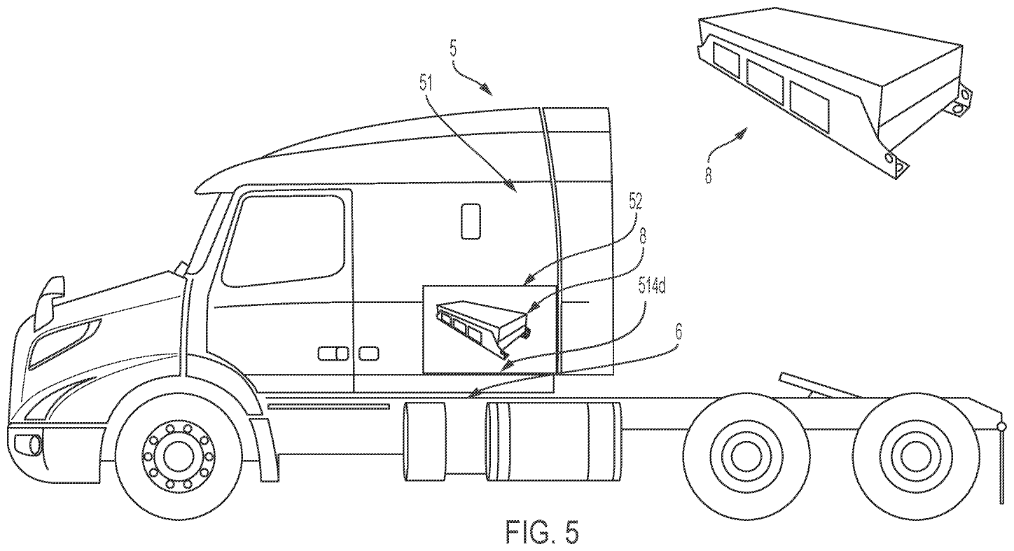

In one embodiment, for safety reason, the cavity 515 may be isolated from the bunk space 51 by the receptacle box wall 514. The cavity 515 thereby may be isolated from the whole sleeper compartment 5 or sleeper cab. In a preferred embodiment, the receptacle box wall 514 may be made of fire-retardant material. Then the receptacle box 52 may become a firewall between the cavity 515 and the rest of the sleeper cab or sleeper compartment (e.g., the mattress 512 of the bunk space 51). Using such an arrangement, in an emergency event, such as off gassing, the gases will not be exhausted to the inside of the sleeper cab, such as the bunk space 51 of the sleeper compartment 5. Such isolation may be also preferred in other emergency situations. For example, when there is an overvoltage event, or the package of the ESS 8 (shown in FIGS. 4 and 5) is penetrated by something. In an embodiment, when a driving space has a separation wall which also forms an exterior surface of a sleeper cab, the exterior surface may be similarly a firewall between the cavity 515 and the rest of the sleeper cab or sleeper compartment.

With continued reference to FIG. 3, the ESS receptacle box 52 may run through the space underneath the mattress 512 along its longitudinal axis thus may have the same length as the mattress 512. FIG. 3 shows a cross-sectional view of a bunk space 51, which may be included in a sleeper compartment, looking from the passenger side of the sleeper cab as shown in FIG. 1. In FIG. 3, the ESS receptacle box 52 and accordingly the cavity 515 is located in the center of the space underneath the mattress 512. Therefore, the receptacle box wall 514 may be independent of all the side walls 511 of the sleeper compartment.

In another embodiment, the ESS receptacle box 52 may merely occupy a part of the space underneath a mattress of the bunk space. Specifically, it's envisioned that merely a portion of the ESS receptacle box 52, accordingly the cavity 515, is located underneath the mattress 512. It may be understood from the different designs of sleeper cabs illustrated in FIGS. 2A-2C, there may be various designs and thus various configurations for a sleeper compartment. One scenario may be the available space may accommodate only a portion of the ESS receptacle box 52. Then the ESS receptacle box 52 may be surrounded by other appliance, furniture, equipment or the like within the bunk space or the sleeper compartment, or surrounded by a specific shape of the bunk space or the sleeper compartment itself.

For example, with reference to FIG. 2B, the ESS receptacle box 52 may partially located under the mattress 512 and partially under the mini fridge. Accordingly, the ESS receptacle box 52 may occupy a portion of the space underneath of the mattress 512 and a portion of the space underneath of the mini fridge. Similarly, the ESS receptacle box 52 may be partially located under the mattress 512 and partially under the closet 53 as shown in FIG. 2C. As another example, for a L shape mattress, an ESS receptacle box may occupy the space underneath either the longer side or the shorter side of the mattress.

In yet another example, in certain scenarios, it's also envisioned that a part of the space underneath a mattress of the sleeper compartment is large enough to provide the ESS receptacle box. For example, when the ESS to be housed is smaller than the mattress space (e.g., the ESS receptacle box 52 in FIG. 3 is narrower than the mattress 512), the ESS receptacle box 52 may have a relatively small size as well. In this case, merely a part of the space underneath of the mattress may be large enough to house the entire ESS receptacle box 52. Another example may be, the height of the mattress 512 is much larger than a height that the ESS receptacle box 52 requires. Therefore, as shown in FIG. 3, the ESS receptacle box 52 is located underneath and has a certain distance from the mattress. This means the ESS receptacle box 52 is spaced from a supporting structure or frame of the mattress 512. By contrast, in a scenario wherein the ESS receptacle box 52 needs a higher space to house an ESS, the ESS receptacle box 52 itself (the sleeper compartment facing side 514b) may function as a support for the mattress 512.

With continued reference to FIG. 3, from the cross-sectional view of the ESS receptacle box 52, a rectangular cavity 515 is shown. However, it may be understood that any other appropriate shape may be used, depending on the specific structure of a sleeper compartment and the shape of an ESS to be housed therein.

With continued reference to FIG. 3, the receptacle box wall 514 may have the 514a side and 514c side define the depth of the cavity 515 while leave the 514d side open. A portion of the floor 513 of the sleeper compartment is cut out to form the cavity 515. An ESS to be housed therein may have a smaller or the same height. In this situation, an ESS may be completely enclosed by the ESS receptacle box 52, except its bottom side which is fixed on the chassis 6 of vehicle 1 (as shown in FIG. 4). It may be understood that an ESS may also have a larger height as compared to the depth of the cavity 515. Then a portion of the ESS may be housed within the cavity 515 thereby that portion may be located above the floor of the sleeper compartment. This may happen in a plurality of scenarios. For example, when the floor of the sleeper cab is not completely flat, and the floor of the sleeper compartment, which may be a separate floor or a sleeper compartment or bunk area of an integral floor, is higher than other area of the sleeper cab. A plurality of factors may have an influence, such as the environment of a bunk space or a sleeper compartment, the shape of the floor of a sleeper cab itself, or even the design and shape of a chassis.

FIG. 4 shows a perspective view of the sleeper cab shown in FIG. 1, whose sleeper compartment 5 may be provided with the ESS receptacle box 52 illustrated in FIG. 3. As discussed above, the receptacle box wall 514 may leave its 514d side open, and the bottom of the ESS may be fixed on the chassis 6 of vehicle 1. In this case, a separate support component (or sheet or board) 9 may be provided for the ESS receptacle box 52. Such separate support component 9 may be made of any appropriate material to support and protect the ESS receptacle box 52 from wear and tear, and/or vibrations. For example, isolators like rubber bushings may be used under the bottom of the ESS 8 as the separate support component 9, to isolate the ESS 8 from vibrations or the like. During the assembly procedure, such support component 9 may be installed on the chassis 6 first, then the ESS mounted thereon. The ESS 8 may be mounted transversely across the frame rail of the chassis 6. The ESS 8 may be fixed on the separate support component 9 in any appropriate way (e.g., fixed with bolts). Then the sleeper compartment 5 may be aligned to and stack on the ESS, if the sleeper compartment 5 is designed and manufactured separately and mated with the driver compartment 4. If the sleeper compartment 5 is integral with the driver compartment 4, then the whole sleeper cab may be stack on the ESS. In such scenario, the ESS 8 is inserted into the cavity 515 from the cavity defining side 514d shown in FIG. 3.

As discussed above and show in FIG. 3, the receptacle box wall 514 may be independent of all the side walls 511 of the sleeper compartment. FIG. 5 shows another scenario, wherein the ESS receptacle box 52, and accordingly the cavity 515, is located at a non-central position of the cross-section of the space underneath the mattress 512 (e.g., closer to one side wall 511). In FIG. 5, the ESS receptacle box 52 is located closer to the rear side wall 511 of the sleeper compartment 5. In this case, the ESS receptacle box 52 occupies merely a portion of the cross-section of the space underneath the mattress 512. Therefore, the receptacle box wall 514 may include a portion of the rear side wall of the sleeper compartment 5. In other words, the rear side wall 511 is provided as a part of the receptacle box wall 514 as well. In another scenario, which is not show in FIG. 5, the ESS receptacle box 52 may have approximately the same width as the mattress 512. Then the receptacle box wall 514 may additionally include a portion of the front wall 511 of the sleeper compartment 5, which is located underneath the mattress 512. It is understood that with different designs of a sleeper compartment, the receptacle box wall 514 may share a wall with one or more side walls of a sleeper compartment. That is to say, the receptacle box wall 514 may include at least a portion of one or more side walls.

FIG. 5 shows another perspective view of the sleeper cab shown in FIG. 1, whose sleeper compartment 5 may be provided with the ESS receptacle box 52 illustrated in FIG. 3. In this embodiment, the ESS 8 may be loaded into the cavity 515 after the sleeper compartment 5 is installed on the chassis 6. For a better view of the internal structure, with continued reference to FIG. 3, a portion of the exterior surface of the sleeper compartment 5 is carved out. The area being carved out is shown as a bold block in FIG. 5. With reference to FIG. 3, this area may be a portion of the side wall 511 of the sleeper compartment 5. In an embodiment, when the side wall 511 itself is a portion of the exterior surface of the sleeper cab, this area may have the same size as the cavity 515. Otherwise, this carved out area may have the same or larger size as the cavity 515, which allows the cavity 515 be accessible from an exterior of the sleeper compartment 5. In an embodiment, in either case, the carved out area may form a separate side panel. This side panel may be open and closed separately. The cavity 515, and thus the inside ESS 8, may be accessible upon opening of the side panel. Therefore, the side panel may also be referred to as a side door. With the ESS receptacle box 52 shown in FIG. 3, there may be another side panel on the passenger side of vehicle 1. In an embodiment, considering the aerodynamic performance or for aesthetic reasons, the side panel may be painted to make it appears like an integral part of the exterior surface of the sleeper cab.

With continued reference to FIG. 5, the ESS 8 may be loaded through either side panel, on the driver side or the passenger side. In one embodiment, the ESS 8 may slide into the cavity 515 by a drawer system on rollers. In another embodiment, the ESS 8 may have a support structure to receive forks of a forklift. Then instead of being slide, the ESS 8 may be loaded into the cavity 515 by the forks that go through from either one of the side panels.

In the embodiment shown in FIG. 5, the floor of the sleeper compartment may enclose the opening side (e.g., side 514d) of the ESS receptacle box 512. Thus the floor of the sleeper compartment forms a portion of the receptacle box wall 514. This floor may also be a part of the floor of the sleeper cab (which may comprise the floor of the driver compartment 4 as well) or the vehicle body floor. In this case, the ESS sits on the floor directly. In an embodiment wherein the separate support component 9 is provided, the separate support component 9 may be inserted into the cavity 515 from a side panel first. The side panel may be on either the driver side or the passenger side or at any appropriate location of a sleeper compartment (e.g., at the back). Then the ESS 8 may be inserted into the cavity 515 from the side panel and sits on the separate support component 9.

In another embodiment, there may be one side panel and the ESS 8 may be slide in and out from a single side. This may be done, for example, in the situation that the ESS receptacle box 52 is located under a portion of the space underneath the mattress 512 along its longitudinal axis, rather than running through as shown in FIG. 3. In another illustrating example, the side panel or side door may be located at other locations, depending on the location of the ESS receptacle box 52 and the specific design of a sleeper compartment. For example, the side panel may be at the back of a sleeper compartment, or at both the back and the driver or passenger side when the ESS receptacle box 52 is located at a corner of the sleeper compartment.

In an embodiment, other modules of the ESS 8, which are not shown in the figures, may be arranged in a plurality of ways. One concern may be the ease of serviceability. Another concern may be how to utilize the space in an efficient way, upon consideration of the specific shape of the ESS receptacle box 52. For example, a service box with high voltage (e.g., 660V) connections may be deployed on one side of the ESS 8, and thermal system (e.g., a vent, coolant system and coolant connections thereof) may be deployed on the other side.

With continued reference to FIG. 5, in an embodiment, for ease of serviceability, the ESS 8 may be releasably inserted into the cavity 515. For example, the bottom of the ESS 8 may be releasably fixed onto the chassis 6 or the separate support component 9, while its top side may be housed within the cavity 515 without a physical connection therewith. Then after being released from the chassis 6 or the separate support component 9 (e.g., unbolted), the ESS 8 may be slid in and out of the cavity 515 as needed. For example, the ESS 8 may be removed in an emergency event, or when there may be a need to change the ESS 8 or for maintenance (e.g., for the coolant system, the connections thereof or the like). Upon such releasable insertion, the ESS 8 may be removable from the chassis 6 or the separate support component 9 without removing the sleeper compartment or the sleeper cab first.

In an embodiment, the thermal system may include a cooling system and a heating system or a heat exchanger. the thermal system of the ESS may be integrated with the heating and cooling system of the sleeper compartment or sleeper cab. Then in the winter, the heat generated in the ESS (e.g., generated by a battery during a charging) may be used to heat the sleeper cab. This is particularly an efficient way for a hybrid electric vehicle to utilize plenty of heat it generated, which may be as high as several hundred degree. In the summer, the ESS cooling system may aid in cooling down the sleeper cab as well.

In an embodiment, a vent is an important module of the ESS as a safety measure. In case of a thermal issue, such as an off gassing, the vent may be selectively opened to release gasses generated by the ESS 8 from the cavity 515. In a preferred embodiment, the side panel may also be preferred to be released as soon as possible upon such thermal event, to allow the gas to be exhausted through the side of the vehicle 1 without blockage. In an embodiment, the release may be carried out with manual intervention at a certain degree. For example, a driver may unlatch the panel upon receiving a notification of the thermal event on the control display.

In a preferred embodiment, the side panel may be preferred to have an automatic release feature which allows a quick disconnect from the vehicle. This means an automatic releasing of the side panel without any manual intervention. There may be a plurality of appropriate ways to implement this feature. Such as by unlatching and dropping the side panel off the vehicle, or by disconnecting/unlatching the side panel and raising/swing it upward. Then the heat and gas inside the cavity, which may be underneath the bunk space or the sleeper compartment, will not be trapped therein. The thermal event may be detected by a sensor system of the vehicle. The releasing of the side panel may be carried out by an electric motor (e.g., the gas charged shocks may raise the side panel up to allow for off gassing without blockage).

In a preferred embodiment, the ESS being housed within the ESS receptacle box 52 may be released from the chassis 6. In this case, both the side panel and the ESS may be automatically released (e.g., unbolted) together or at a similar time upon an emergency event. Then the ESS may be automatically separated from the chassis of the vehicle, thereby the ESS may later be removed from the vehicle completely, when possible.

In an embodiment, because the cavity 515 is isolated from the sleeper compartment or the whole sleeper cab, a temperature within both the cavity 515 and the sleeper cab may be regulated separately. Then a temperature of the cavity and/or the ESS being housed therein, may be regulated. In an embodiment, a temperature regulation system may be provided for regulating the temperature of the cavity 515 and the sleeper cab respectively. In another embodiment, the temperature regulation system of the ESS and the temperature regulation system of the sleeper cab may be thermally connected with each other.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (just X, or just Y, or just Z) and multiple items (i.e., {X and Y}, {X and Z}, {Y and Z}, or {X, Y, and Z}). “At least one of” is not intended to convey a requirement that each possible item must be present.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A sleeper cab for a heavy truck, the sleeper cab comprising:
a sleeper compartment with side walls, a floor, and a bunk space configured to provide a sleeping space for a driver, the bunk space provided with:
an energy storage system receptacle box provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment from at least one of the side walls or the floor and that is isolated from the sleeper compartment by the receptacle box wall;
wherein, at least a portion of an energy storage system is inserted into the cavity so that at least a portion of the energy storage system is located above the floor.

2. The sleeper cab of claim 1, wherein the cavity is accessible from an exterior of the heavy truck.

3. The sleeper cab of claim 1, wherein a vehicle body floor includes the floor of the sleeper compartment.

4. The sleeper cab of claim 1, wherein the energy storage system is located within the receptacle box and supported by the floor.

5. The sleeper cab of claim 1, wherein the floor within the cavity is at least partially cut out and the energy storage system is located on an energy storage system support that is in the cavity.

6. The sleeper cab of claim 1, wherein the energy storage system is releasably inserted into the cavity so that the energy storage system automatically separates from the heavy truck in an emergency event.

7. The sleeper cab of claim 1, wherein a vent is provided that is selectively opened to release gasses generated by the energy storage system from the cavity.

8. The sleeper cab of claim 1, wherein the energy storage system receptacle box wall is a firewall between the cavity and the sleeper cab.

9. The sleeper cab of claim 1, wherein the energy storage system is an electric battery system.

10. The sleeper cab of claim 1, wherein the energy storage system is a fuel storage system.

11. The sleeper cab of claim 1, wherein the cavity is at least partially located underneath a mattress located in the bunk space.

12. The sleeper cab of claim 1, further comprising a temperature regulation system that regulates a temperature of at least one of the cavity and the energy storage system.

13. The sleeper cab of claim 8, wherein the temperature regulation system of the energy storage system is thermally connected to a temperature regulation system of the sleeper cab.

14. The sleeper cab of claim 1, wherein the energy storage system is removable from a chassis of the heavy truck without removing the sleeper cab from the chassis of the heavy truck.

15. The sleeper cab of claim 1, wherein the energy storage system comprises a support structure that is configured to receive forks of a forklift to remove the energy storage system from a chassis.

16. A sleeper cab for a heavy truck, the sleeper cab comprising:
a sleeper compartment with side walls, a floor, and a bunk space configured to provide a sleeping space for a driver, the bunk space provided with:
an energy storage system receptacle box provided with a receptacle box wall that extends inward into the sleeper compartment from at least one of the side walls or the floor and that includes a sleeper compartment facing side and cavity defining side opposite the sleeper compartment facing side, the cavity defining side defining a cavity that extends into the sleeper compartment space from at least one of the side walls or the floor and that is isolated from the sleeper compartment by the receptacle box wall;
a driving space configured to provide space for the driver to operate the heavy truck, the driving space having a driving floor, and a separation wall forming a border with the sleeper compartment; and
an energy storage system, wherein at least a portion of the energy storage system is inserted into the cavity so that at least a portion of the energy storage system is located above the floor of the sleeper compartment.

17. The sleeper cab of claim 16, wherein the energy storage system is releasably inserted into the cavity that the energy storage system automatically separates from the heavy truck in an emergency event.

18. The sleeper cab of claim 16, wherein a vent is provided that is selectively opened to release gasses generated by the energy storage system from the cavity.

19. The sleeper cab of claim 16, energy storage system receptacle box is a firewall between the cavity and the sleeper cab.

20. The sleeper cab of claim 16, wherein the separation wall defines an exterior surface of the sleeper cab, wherein the exterior surface is a firewall between the cavity and the sleeper cab.

21. The sleeper cab of claim 16, wherein the energy storage system is an electric battery system.

22. The sleeper cab of claim 16, wherein the energy storage system is a fuel storage system.

23. The sleeper cab of claim 17, comprising a temperature regulation system that regulates a temperature of at least one of the cavity and the energy storage system.

24. The sleeper cab of claim 17, wherein the energy storage system is removable from a chassis of the heavy truck without removing the sleeper cab.

25. The sleeper cab of claim 23, wherein the temperature regulation system of the energy storage system is thermally connected to a temperature regulation system of the sleeper cab.

26. The sleeper cab of claim 24, wherein the energy storage system comprises a support structure that is configured to receive forks of a forklift to remove the energy storage system from a chassis.
